(19) United States
(12) Patent Application Publication
(10) Pub. No.: US 2012/0242250 A1
(43) Pub. Date: Sep. 27, 2012

(54) DYNAMIC AMBIENCE LIGHTING SYSTEM

(75) Inventors: Etienne Rene Eveline Coezijn, Eindhoven (NL); Guido Galeazzi, Eindhoven (NL); Cornelis Wilhelmus Kwisthout, Eindhoven (NL)

(73) Assignee: KONINKLIJKE PHILIPS ELECTRONICS N.V., EINDHOVEN (NL)

(21) Appl. No.: 13/498,666

(22) PCT Filed: Nov. 11, 2010
(86) PCT No.: PCT/IB10/55119

§ 371 Date: Mar. 28, 2012

(30) Foreign Application Priority Data
Dec. 15, 2009 (EP) 09179300.0

(51) Int. Cl. H05B 37/02

(52) U.S. Cl. 315/297

(57) ABSTRACT

The invention relates to an ambience lighting system, typically for use in conjunction with a display device. The ambience lighting system may be of the type AmbiLight. The ambience lighting system comprises one or more light sources associated to subregions of the display screen; a content characterizer for determining content characteristics of image data of the subregions; and a controller controlling the color of the emitted ambience light of the one or more light sources in accordance with determined content characteristics of the subregions of the display screen. The subregions are configured to move from a prior position to a next position and the content characterizer and the controller are adapted for controlling the color of the emitted ambience light in accordance with the determined content characteristics of the image data of subregions of the next position. A dynamic ambience lighting is thereby obtained.

### FIELD OF THE INVENTION

The invention relates to an ambience lighting system and in particular to an ambience lighting system visual suitable for use in conjunction with a display device.

### BACKGROUND OF THE INVENTION

A number of different types of display devices are known and available to the user, such as television sets based on various technologies. The display devices are normally employed to present images or image sequences to a viewer. In the 1960s, backlighting was introduced due to the fact that televisions required a “darker” room for optimal viewing. Backlighting is in its simplest form white light, emitted from e.g. a light bulb, projected on a surface behind the visual display device. Backlighting has been suggested to be used to relax the iris and reduce eye strain. During recent years the backlighting technology has become more sophisticated and there are several display devices on the market with integrated backlighting features that enables emitting colors with different brightness depending on the visual information presented on the display device. The benefits of backlighting in general includes: a deeper and more immersive viewing experience, improved color, contrast and detail for best picture quality, and reduced eye strain for more relaxed viewing. One example of a commercial available display device with backlighting is the ambience lightning system Ambilight™ as sold by Philips.

A typical Ambilight™ system comprises peripherally arranged light sources for emitting light that appear to the user to illuminate a region surrounding the TV-screen. In a known Ambilight™ system, the system may be operated in a so-called LoungeLight mode where the Ambilight slowly fades between several pre-set colors from a set of pre-defined color schemes. In some systems, it is also possible to upload a wallpaper image to the system to create a static Ambilight effect in standby state.

### SUMMARY OF THE INVENTION

The inventors of the present invention have realized that there is a need to provide a system which on one hand utilizes the opportunities of an ambience lightning system to create the special room atmosphere obtainable by ambience lighting systems, but which on the other hand provides a greater flexibility to the user in terms of influencing the result in relation to the user's preferences. To this end, it would be advantageous to achieve an ambience lightning system provides a more versatile system than available in current systems which to a higher degree enable the user create an individual ambience light experience. In general, the invention preferably seeks to mitigate, alleviate or eliminate one or more of the above mentioned disadvantages, or other disadvantages of the prior art, singly or in any combination.

To better address one or more of these concerns, in a first aspect of the invention an ambience lighting system for use in conjunction with a display device is presented that comprises a display screen, and

one or more light sources adapted for emitting an ambience light, the one or more light sources being disposed in a configuration so that light emitted therefrom illuminates an illumination region visually appearing to a viewer, the one or more light sources each being associated to subregions of the display screen;

a content characterizer adapted for determining content characteristics of image data of the subregions of the display screen;

a controller adapted to control the color of the emitted ambience light of the one or more light sources in accordance with determined content characteristics of the subregions of the display screen;

wherein the subregions are configured to move from a prior position to a next position and wherein the content characterizer is adapted for determining content characteristics of the image data of the subregions of the next position and wherein the controller is adapted to control the color of the emitted ambience light of the one or more light sources in accordance with the determined content characteristics of the image data of subregions of the next position.

By controlling the color of the emitted ambience light based on content characteristic of subregions, where the subregions move from prior regions to next regions, a dynamic ambience lighting system is provided which ensures an ever-changing room illumination based on image content. This ensures a versatile system which provides virtually unlimited opportunities of styles of ambience lighting. The image content may be based on user-preferences, thereby ensuring a dynamic ambience lighting system which renders it possible for a user to tailor an ambience light experience in accordance with his or her preferences.

In advantageous embodiments, the ambience lighting system is of the type where the light sources are positioned at the periphery of the display device or the rear side of the display device, where the illumination region visually appearing to the viewer to at least partly surround the display screen. In embodiments, the light sources may emit light onto a wall or screen behind the display device to provide a back-lighting system or emit light outward towards the viewer to provide an ergo lighting system. In other embodiments, however, the ambience lighting system may be positioned separate from the display device. The term ambience lighting should in the context of the present invention be construed broadly, and in general to include any systems which are capable of, based on an input signal, to emit dynamic light to influence the general lighting of a room or other environment. The control of the light sources may be done in a number of ways and is generally known to the skilled person. In an example, the controller, receives inputs related to such characteristics as intensity and color, which is converted into operational settings such as power settings on the individual sources.

In an advantageous embodiment, the image data of the subregions of the display screen is based on a base image comprising static image data. To facilitate a versatile system which supports flexible user control of selecting the base image, the ambience lighting system may further comprise a memory for storing images. Advantageously, the system supports upload of images as well as storage of pre-installed images. A user is thereby provided with the possibility that the image content is based on an image of his or her choices, while the provider of the ambience lighting system may still ensure that the user is given access to specially selected images which ensures a given style of the emitted ambience light. The use of static image data gives a simple means of controlling the overall atmosphere of the emitted lights, since the user can directly see the colors used, the distribution of the colors etc. Motion image data may nevertheless be used in connection with embodiments of the present invention. Motion image data would give a ‘double’ dynamic effect since the content change both from the movement of the subregions and from the movements of the image data.

In general, the display screen is divided into subregions from which content characteristics are extracted. The subregion may be associated to any subregion, segment or area of the display screen. The shape or form of the subregion is not confined to any particular shape or form, in particular the regions need not to be confined to a single coherent region but may be formed by separate or abutting areas. In advantageous embodiments, the display is divided into a regular grid of tiles, each tile spanning a number of screen pixels, each tile being associated to average values of content characteristics of the screen pixels spanned by the tile, and wherein the subregions are defined as a collection of tiles. By dividing the screen into tiles, a platform is provided which facilitates fast data collection and treatment. The positions of the subregions as well as the movement may be determined by use of a position algorithm.

In a second aspect of the invention a controller for controlling the color of emitted ambience light of an ambience lighting system to which the controller is operatively connected is presented. The controller comprises or is communicatively connected to a

a content characterizer adapted for determining content characteristics of subregions of a display screen associated to the ambience lighting system;

wherein the subregions are configured to move from a prior position to a next position and wherein the content characterizer is adapted for determining content characteristics of the image data of the subregions of the next position and wherein the controller is adapted to control the color of the emitted ambience light of the one or more light sources in accordance with the determined content characteristics of the image data of subregions of the next position.

In a third aspect of the invention a display device comprising an ambience light system according to the first aspect is presented. Such a display device may be in the form of an LCD device, a plasma device, an organic light-emitting diode (OLED) device or projection screen.

In a fourth aspect of the invention a method of operating an ambience lighting system used in conjunction with a display device is presented. The device includes a display screen. The ambience lighting system comprises:

one or more light sources adapted for emitting an ambience light, the one or more light sources being disposed in a configuration so that light emitted therefrom illuminates an illumination region visually appearing to a viewer;

the method comprising:

a) associate each of the one or more light sources to subregions of the display screen;

b) determining content characteristics of the subregions of the display screen;

c) control the color of the emitted ambience light of the one or more light sources in accordance with the determined content characteristics of the subregions;

d) move the subregions to a next position;

e) repeat steps b) to e).

The steps b) to d) may be performed in any order.

In a fifth aspect of the invention, a computer program product is presented, which when running on a computing device, may be implemented to perform the method steps of the third aspect of the invention.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates an embodiment of a display device in the form of a TV equipped with an ambience lighting system;

FIG. 2 illustrates an embodiment of the ambience lighting system where the display is divided into a regular grid of tiles;

FIG. 3 illustrates an embodiment, wherein the image data of the subregions of the display screen is based on a base image comprising static image data

FIG. 4 shows an example of the resulting ambience lighting obtained by embodiments of the present invention;

FIG. 5 is a schematic illustration of the ambience lighting obtained by embodiments of the present invention; and

FIG. 6 schematically illustrates an embodiment of general steps in the operation of an ambience lighting system in accordance with the present invention.

### DESCRIPTION OF EMBODIMENTS

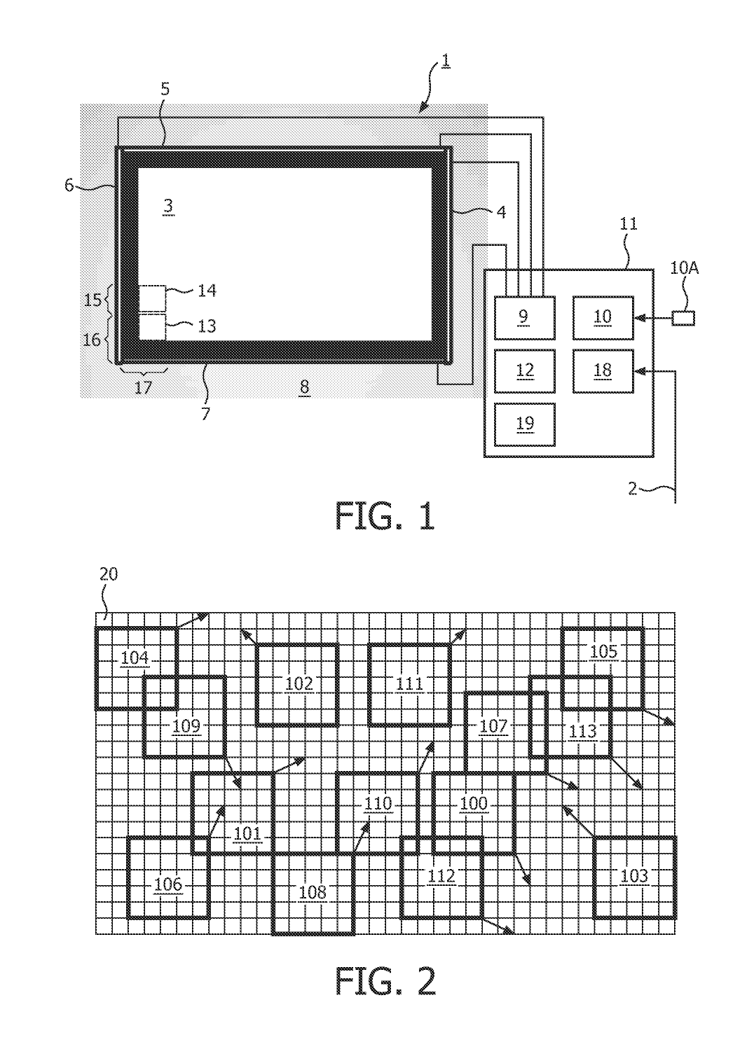

FIG. 1 illustrates an embodiment of a display device 1 in the form of a TV equipped with an ambience lighting system in accordance with embodiments of the present invention. As an example the display device may be a flat-screen TV with Ambilight™ backlighting, as sold by Philips. In the following, the focus is on embodiments of a display device in the form of a TV-set with an at least partly peripheral backlighting system, however the invention is not limited to such a system, instead embodiments of the invention may be used in any type of visual display system employing ambience lighting. An example of an alternative or additional ambience lighting system is a separate illumination source, such as a lamp having a lamp driver which is communicatively connected to a TV-screen, such that the illumination or light emitted by this separate source varies in accordance with content characteristics of the subregions of the display screen. In this situation, an average content characteristic of the subregions may be used to drive the separate illumination source, or a dedicated or group of subregions may be associated to the separate illumination source.

FIG. 1 illustrates an ambience lighting system that is used in conjunction with a display device having a display screen 3, i.e. the TV-screen. The system comprises one or more light sources 4-7 adapted for emitting ambience light. The light sources are disposed in a configuration so that light emitted therefrom illuminates an illumination region 8 visually appearing to the viewer. In the shown embodiment, four light sources are present, a top light source 5, a bottom light source 7 and two side light sources, i.e. a right light source 4 and a left light source 6. Other configurations of the light sources include, but are not limited to, three light sources with a top and the side light sources 4-6, and two light sources being the side light sources 4, 6. The illumination region 8 is a wall or screen behind the TV-set. In embodiments, the light source may also be comprised or connected to the frame of the TV so that the frame forms part of, or is, the illumination region. In the illustrated embodiment, the light sources are illustrated as four individual light sources. Each light source may however be based on a number of individually controlled units or each of the illustrated light sources may be understood as a simplified representation of a collection of individually controlled units.

The ambience lighting system comprises a controller 9 for controlling the light sources. Moreover, a data processor 10 may be present, for general data handling of the system. The controller and the data processor unit and possible other units may be part the electronic elements 11 of the TV-set. Such elements are typically placed in the housing of the TV-set, behind the TV-screen or image display region 3. Here the elements are displayed separate from the TV for illustrative reasons. The ambience lighting system may further comprising an input unit 18 adapted for receiving input commands 2 from a user. Such input commands may be related to preference settings of the user.

Moreover, the ambience lighting system may comprise a content characterizer 12 adapted for determining content characteristics of subregions 13, 14 of the display screen. These subregions may each be associated to light sources, or sections of light sources 15-17, in the sense that the light emitted from a light source is based on content characteristics from a subregion to which it is associated. In advantageous embodiments the content characteristics are selected from, but not limited to, the group consisting of: a brightness measure, a contrast measure, saturation measure, a measure of 3D depth of the content displayed on the display screen or a combination of one or more thereof. The graphic processor of a modern TV-set may generate a number of content characteristic measures for a number of reasons. In embodiments may such content characteristic measures which are generated for other purposes be used in connection with controlling the emitted ambience light. In general, however, may any suitable content characteristic be used.

The electronic elements 11 are illustrated in terms of functional units. In general the electronic elements may be implemented as an integrated circuit comprising programmable parts as well as specific non-programmable electronic components where the programmable parts, such as the data processor 10, may be shared between different functional units. For example part of the data processor may be implemented as the content characterizer which again may be comprised in or communicatively connected to the controller 9. In general, the functionality of the controller and the content characterizer, as well as other components, may be implemented by a computer program product which is run by the data processor 10. The data processor 10 may e.g. be provided with the functionality of receiving a computer program product 10A, such as computer code, in any appropriate form.

The light sources 4-7 may in different embodiments be different types of sources. The light sources may e.g. be cold cathode fluorescence lamps (CCFL) or light emitting diodes (LED), but are not limited to such light sources. For light sources of the CCFL type, the control unit would comprise a lamp driver including a lamp inverter for operating the CCFL sources, whereas for light sources comprising LEDs, the control unit would comprise a lamp driver for operating the LED sources.

In the shown example, the color of the light source element 15 may be based on content characteristic from the subsection 14 to which it is associated, and the color of the light source elements 16 and 17 may be based on a content characteristic from the subsection 13 to which they are associated. In this figure, the light sources are associated to edge-related subregion. In general, the subregions may be positioned at any suitable area on the display screen.

In embodiments, the content characterizer 12 is generally implemented to determine content characteristics of all subregions of the display screen. Based on the determined content characteristics, the controller controls the color of the emitted ambience light of the sources in accordance with the determined content characteristics of the subregions.

FIG. 2 illustrates an embodiment of the ambience lighting system where the display is divided into a regular grid of tiles 20, each tile spanning a number of screen pixels depending on the screen resolution. Each tile is associated to average values of content characteristics of the screen pixels spanned by the tile. In the illustrated embodiment, the display is divided into 36 horizontal and 20 vertical non-overlapping tiles. In an embodiment, the subregions are defined as collection of tiles 100-114. For example each subregion 100-114 may be spanned by 5×5 tiles.

In general, the subregions are configured to move from a prior position to a next position. The content characterizer is adapted to determine the content characteristics of the image data of the subregions of the next position and the controller is adapted to control the color of the emitted ambience light of the one or more light sources in accordance with the determined content characteristics of the image data of subregions of the next position. In an embodiment, the initial configuration of the subregions may be selected in accordance with a predefined position algorithm which selects an initial position and a speed vector of each of the subregions. The initial configuration may be set to be the first prior position and the next position for each subregion is determined based on the selected speed vector. The next prior position may subsequently be set as the former next position and so forth. This is illustrated in FIG. 2 by a speed vector associated to each subregion. In an embodiment, the subregions are initially configured to move along the screen with a speed of 4/256th of a tile per frame for a 50 Hz signal in a down-left direction. Upon ‘hitting’ the screen boundary the signal of the vector component perpendicular to the screen boundary is changed resulting in that the subregion will ‘bounce’. The result is that the subregions slowly move about on the screen. In an alternative embodiment, the subregions may exit the screen at one side and re-enter at an opposite side. However, this may only be used for content with similar colors at the edges to avoid jumps in the ambience color. In embodiments, the position algorithm may select the initial position by applying a random or pseudo random selection. The speed vector may be selected as a constant speed vector, however in other embodiments, the speed vectors may be selected within a specified speed range. The speed vector may also be based on user input, for example to determine the size of the speed or the range, so as to determine a time constant of the modulation of the light sources.

In another embodiment, the next position of the subregions is based on a position selection algorithm which determines the next position in accordance with a selection algorithm. The selection algorithm may e.g. select the next position in a random or pseudo-random manner, or in accordance with predetermined dynamic modulation patterns of the subregions.

In an embodiment the subregions may be restricted to move in a preset area of the screen. The restriction may e.g. be based on user input. For example, the user may select the specific area in which the subregions can move, additional, the user may associate a group of the light sources to a specific user selected area, and one or more other groups of the light sources to another selected area.

In an embodiment, the position algorithm may support user-definable paths along which the subregions move. The next position may thus be selected in accordance with user inputs. The system may be implemented with a facility which allows the user to draw paths or trajectories for individual, groups of, or all subregions. The position algorithm may also base a path on user inputs. For example, the user may draw, or by any other means define a template path, which the position algorithm may stretch, rotate, enlarge, shrink, etc, to continuously vary the movement of the subregions. Such user-definable paths may even be stored and/or uploaded to enable detailed user control of the created ambience light atmosphere. A created atmosphere may then be shared with other users.

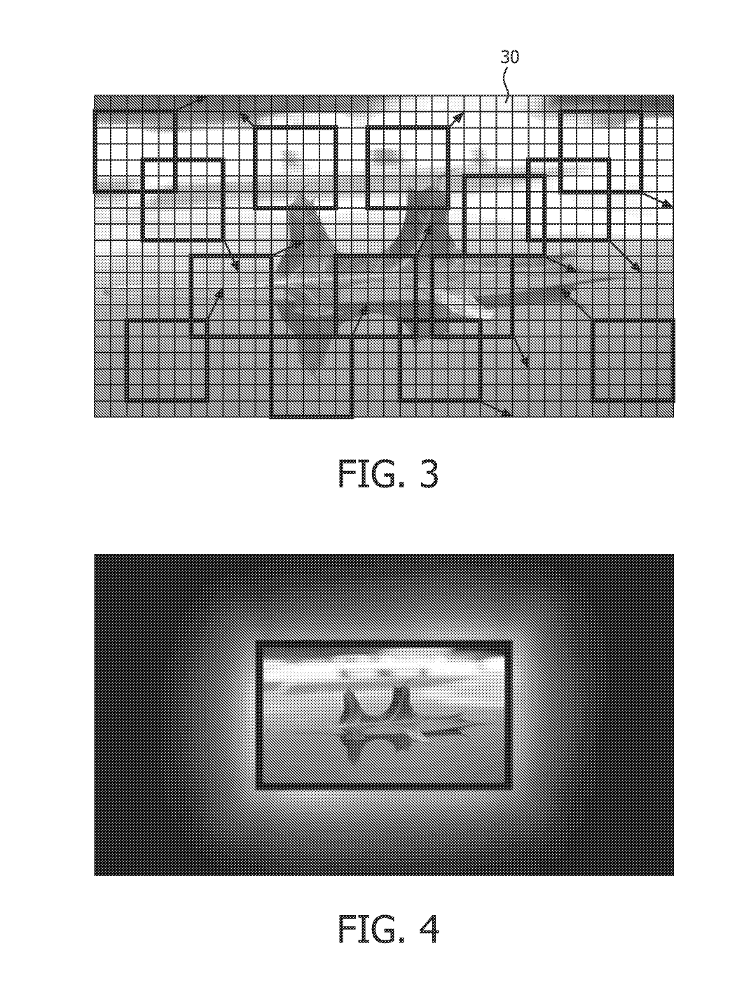

FIG. 3 illustrates an embodiment, wherein the image data of the subregions of the display screen is based on a base image 30 comprising static image data. The base image may e.g. be provided in the form of a static video signal, in embodiments, it may be deduced directly from the image data, from screen content, from a signal suitable for presenting image data on the screen, or from any suitable means. The ambience lighting system may further comprise a memory for storing images. The memory may e.g. be part of the electronic elements 11 or be communicatively connected to the electronic elements 11. In FIG. 1 a memory 19 is illustrated as a part of the electronic elements 11. A memory support storage of and selection among a collection of images. In an embodiment, system may be provided with the functionality that a user may select an images stored by the memory, where the image is used as base image for extracted content characteristics. In an embodiment, the ambience lighting system may comprise an image extractor for extracting static image data from motion image data displayed on the display screen and for configuring such extracted image data into a base image and/or for storing the extracted image in the memory. In alternative or additional embodiments, such images as digital photos or other images may be used as base image. The data processor may comprise a module which support standard image formats.

FIG. 4 shows an example of the resulting ambience lighting obtained by embodiments of the present invention. The figure shows a ‘snap shot’, in a situation of use, the ambience lighting will slowly be modulated in accordance with the movements of the subregions.

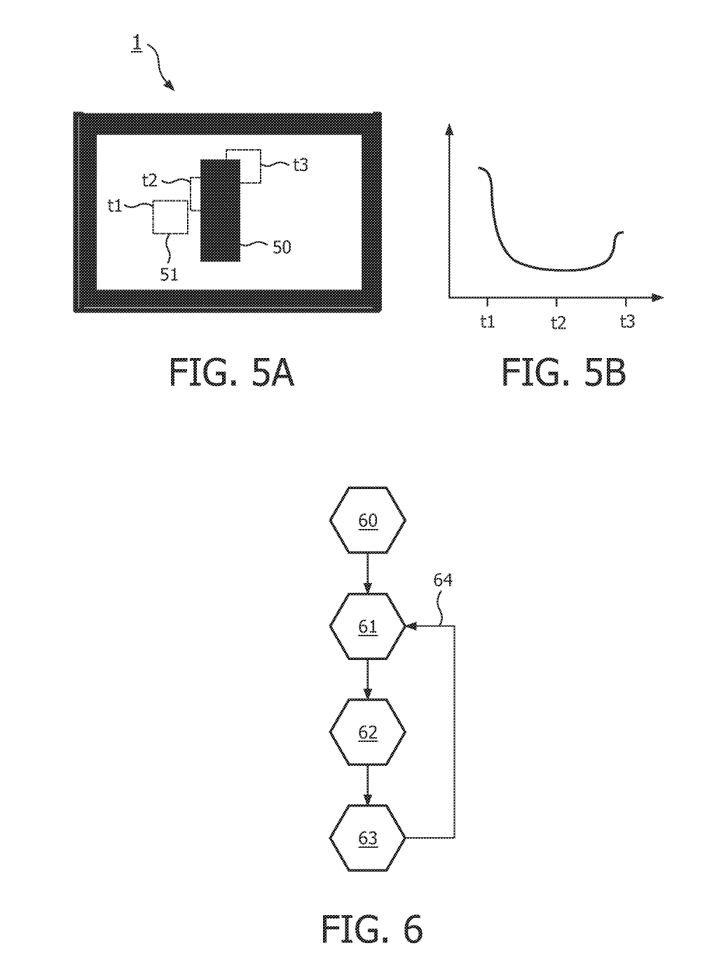

FIG. 5 schematically further illustrates the resulting ambience lighting obtained by embodiments of the present invention. FIG. 5A shows a display device 1 displaying a simple static image. The image shows a centrally placed black box 50, and a subregion 51 at three consecutive time instances t1-t3. The figure thus illustrates a situation where a subregion moves from a bright area over a dark area to a bright area. FIG. 5B schematically illustrates the resulting content characteristic, in the form of the intensity along the vertical axis as a function of time along the horizontal axis. A light source associated to the subregion 51 would in embodiments emit a bright light at time t1, the light is clearly dimmed at time t2 and slight increased at time t3 as compared to time t2.

In a further embodiment, the one or more light sources are each being associated to two or more subregions of the display screen, and wherein the controller adapted to control the color of the emitted ambience light of the one or more light sources in accordance with combined content characteristics of the two or more subregions. In an embodiment, two (or more) subregions may define the final output used to control a light source: one subregion could be positioned in an area near, or even abutting, the light source, while another subregion move in accordance with embodiments disclosed above. Accordingly, a subgroup of the subregions move, while another subgroup remains in a fixed position. The first subregion could for example be used to determine the (local) color of the content in that area. The second subgroup moves over the content and is for example used to determine the brightness, contrast, or other content characteristics. The combination of the content characteristics gives the resulting color. Such an embodiment, could advantageously be used when the TV display stays on. Using this embodiment, some of the content characteristics, e.g. RGB or other equivalent components, could be derived from the screen edges similar to standard ambience lighting systems, but the emitted color is made dynamic by getting the brightness (or other content characteristic) information from a moving location of the content.

FIG. 6 schematically illustrates an embodiment of general steps in the operation of an ambience lighting system in accordance with the present invention. The ambience lighting system may e.g. be a system as disclosed in connection with FIG. 1. The method comprising:

60: associate each of the one or more light sources to subregions of the display screen;
61: determining content characteristics of the subregions of the display screen;
62: control the color of the emitted ambience light of the one or more light sources in accordance with the determined content characteristics of the subregions;
63: move the subregions to a next position; and
64 repeat steps 61 to 63.

Embodiments of the present invention may e.g. be used in connection with an off-state of the display device, in the sense that the display device is not used for presenting motion data. In general, embodiments of the invention may be used in a variety of applications, e.g. in connection with picture browsing for viewing digital photos, for internet browsing or for other modes. The base image need not be, but may be, displayed on the display screen during application of embodiments of the present invention.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. An ambience lighting system for use in conjunction with a display device (1) including a display screen (3), the system comprising:
one or more light sources (4-7,15-17) adapted for emitting an ambience light, the one or more light sources being disposed in a configuration so that light emitted therefrom illuminates an illumination region (8) visually appearing to a viewer, the one or more light sources each being associated to subregions (13,14,100-113) of the display screen;
a content characterizer (12) adapted for determining content characteristics of image data of the subregions of the display screen;
a controller (9) adapted to control the color of the emitted ambience light of the one or more light sources in accordance with determined content characteristics of the subregions of the display screen;
wherein the subregions are configured to move from a prior position to a next position and wherein the content characterizer is adapted for determining content characteristics of the image data of the subregions of the next position and wherein the controller is adapted to control the color of the emitted ambience light of the one or more light sources in accordance with the determined content characteristics of the image data of subregions of the next position.

2. The ambience lighting system according to claim 1, wherein the image data of the subregions of the display screen is based on a base image (30) comprising static image data.

3. The ambience lighting system according to claim 2, further comprising a memory (19) for storing images, wherein the base image is selectable from images stored by the memory.

4. The ambience lighting system according to claim 3, wherein the memory supports upload of images.

5. The ambience lighting system according to claim 3, wherein the memory stores pre-installed images.

6. The ambience lighting system further comprising an image extractor for extracting static image data from motion image data displayed on the display screen and for configuring such extracted image data into a base image and/or for storing the extracted image in the memory.

7. The ambience lighting system wherein the display is divided into a regular grid of tiles (20), each tile spanning a number of screen pixels, each tile being associated to average values of content characteristics of the screen pixels spanned by the tile, and wherein the subregions are defined as a collection of tiles.

8. The ambience lighting system according to claim 7, wherein an initial configuration of the subregions is selected in accordance with a predefined position algorithm, wherein the position algorithm selects an initial position and a speed vector of each of the subregions, and wherein the next position for each subregion is determined based on the selected speed vector.

9. The ambience lighting system according to claim 7, wherein the next position of the subregions is based on a position algorithm which determines the next position in accordance with a selection algorithm.

10. The ambience lighting system according to claim 1, wherein the light sources (4-7,15-17) are positioned at the periphery of the display device or the rear side of the display device, and wherein the illumination region (8) visually appearing to the viewer to at least partly surround the display screen.

11. A controller (9) for controlling the color of emitted ambience light of an ambience lighting system to which the controller is operatively connected, the ambience lighting system comprises one or more lighting sources (4-7, 15-17), the controller comprises or is communicatively connected to a
a content characterizer (12) adapted for determining content characteristics of subregions of a display screen associated to the ambience lighting system;
wherein the subregions are configured to move from a prior position to a next position and wherein the content characterizer is adapted for determining content characteristics of the image data of the subregions of the next position and wherein the controller is adapted to control the color of the emitted ambience light of the one or more light sources in accordance with the determined content characteristics of the image data of subregions of the next position.

12. A display device (1) comprising an ambience light system as claimed in claim 1.

13. A display device (1) according to claim 8, where the display device is selected from the group of: an LCD device, a plasma device, an organic light-emitting diode (OLED) device or projection screen.

14. Method of operating an ambience lighting system used in conjunction with a display device (1) including a display screen (3), the ambience lighting system comprises:
one or more light sources (4-7,15-17) adapted for emitting an ambience light, the one or more light sources being disposed in a configuration so that light emitted therefrom illuminates an illumination region (8) visually appearing to a viewer;
the method comprising:
a) associate (60) each of the one or more light sources to subregions of the display screen;
b) determining (61) content characteristics of image data of the subregions of the display screen;
c) control (62) the color of the emitted ambience light of the one or more light sources in accordance with the determined content characteristics of the subregions;
d) move (63) the subregions to a next position; and
e) repeat (64) steps b) to e).

15. A computer program product (10A) adapted to, when running on a computing device, to perform the method steps of claim 14.
